(19) United States
(12) Patent Application Publication
(10) Pub. No.: US 2008/0281709 A1
(43) Pub. Date: Nov. 13, 2008

(54) ADVERTISING METHOD AND METHOD OF SHARING ADVERTISEMENT REVENUE

(75) Inventors: Sung Uk CHOI, Seongnam-si (KR); Woosung LEE, Seoul (KR)

Correspondence Address: KNOBBE MARTENS OLSON & BEAR LLP, 2040 MAIN STREET, FOURTEENTH FLOOR, IRVINE, CA, 92614, US

(73) Assignee: NHN CORPORATION, Seongnam-si (KR)

(21) Appl. No.: 12/118,507

(22) Filed: May 9, 2008

(30) Foreign Application Priority Data
May 11, 2007 (KR) 10-2007-0045828

(51) Int. Cl. G06Q 30/00

(52) U.S. Cl. 705/14

(57) ABSTRACT

A method of sharing an advertisement revenue is provided. The method includes: receiving a request from a first user for posting a content item on a webpage of a website; posting the content item on the webpage; receiving from a second user a request for the content item for displaying, playing, or downloading on a terminal of the second user; sending the requested content item for displaying, playing or storing on the second user's terminal; in connection with sending the requested content item, causing an advertisement to be displayed or played on the second user's terminal; and sharing with the first user a revenue generated from causing the advertisement to be displayed or played on the second user's terminal in connection with sending the requested content item to the second user's terminal.

### CROSS-REFERENCE TO RELATED APPLICATION

This application claims the benefit of Korean Patent Application No. 10-2007-0045828, filed on May 11, 2007, in the Korean Intellectual Property Office, the disclosure of which is incorporated herein by reference in its entirety.

### BACKGROUND

1. Field

The present disclosure relates to an advertising method on a webpage and a method of sharing revenue from the advertisement among users of the webpage.

2. Discussion of Related Technology

A typical advertisement scheme generally advertises a particular product using a newspaper, a book, a physical signboard, a placard, and the like. However, due to the development of a personal computer (PC) and fast distribution of the Internet, an advertising system using the Internet is currently popular. An example of an Internet advertisement is a banner advertisement. The banner advertisement indicates an advertisement scheme that attaches a name or content of a particular website to one side of popular webpage to thereby advertise a product. In the initial stage, the banner advertisement had a simple structure of informing a domain and business content in a square shape. Currently, the banner advertisement is being diversified. For example, the banner advertisement may be included in a moving picture or may be fixed to a screen when a webpage is open.

The foregoing discussion is to provide general background information, and does not constitute an admission of prior art.

### SUMMARY

One of the embodiments provides a method of sharing an advertisement revenue, wherein the method comprises: receiving a request from a first user for posting a content item on a webpage of a website; posting the content item on the webpage; receiving from a second user a request for the content item for displaying, playing, or downloading on a terminal of the second user; sending the requested content item for displaying, playing or storing on the second user's terminal; in connection with sending the requested content item, causing an advertisement to be displayed or played on the second user's terminal; and sharing with the first user a revenue generated from causing the advertisement to be displayed or played on the second user's terminal in connection with sending the requested content item to the second user's terminal.

In the foregoing method, the content item comprises at least one selected from the group consisting of a still image, a motion image, a sound recording, a computer game, a video clip, and a song. Also when posting a content item on a webpage, the webpage may be selected from the group consisting of a page of an internet portal website, a page of content distribution website, a page of an internet search website, a blog page, or a page of a social networking website. Also when a user posts a content item to these webpages, the user typically identifies the document or file to post and submit to a server computer a request for posting by clicking a link or button for uploading the document or file. The server computer processes the request and posts the document or file so that it is available on the webpage. The request for posting further comprises a request for scraping the content item from another webpage that has posted the content item and comprises providing an anchor tag on the webpage for initiating to play or display the content item on a computing device connected to the webpage.

Still in the foregoing method the causing of advertisement to be played or displayed on the second user's terminal comprises sending the advertisement to the second user's terminal or sending a command to the second user's terminal to play or display the advertisement that has been stored in the second user's terminal. Also, causing may comprise the advertisement displayed or played before or after displaying, playing or storing of the content item on the second user's terminal. Causing may further comprise the advertisement displayed or played while displaying, playing or storing of the content item on the second user's terminal.

The content item in the foregoing method comprises data to be displayed or played on a computing terminal and further comprises information identifying the advertisement, wherein the method further comprises selecting the advertisement by referring to the information upon receiving the request for the content item. The content item also comprises data to be displayed or played on a computing terminal and further comprises information describing the content item, wherein the method further comprises selecting the advertisement by referring to the information and referring to an advertisement database. The said selecting of the advertisement comprises processing the information so as to extract at least one keyword and searching in the advertisement database using the at least one keyword so as to locate said advertisement. The information describing the content item may be incorporated in the content item while creating the content item or when the content item is uploaded. The information may be selected from the group consisting of a title of the content item, one or more descriptive keywords for the content item, one or more names of creator(s) of the content item, one or more names of contributor(s) of the content item, date or time of creating of the content item, and date or time of posting of the content item.

In the foregoing method, the sharing of the revenue from advertisement comprises providing the first user with a contribution point for causing the advertisement to be displayed or played on the second user's terminal and calculating a portion of the revenue to be shared with the first user using the contribution point. The sharing of the revenue from advertising in the foregoing method further comprises: receiving from a third user a request for the content item for displaying, playing, or downloading on a terminal of the third user; sending the requested content item for displaying, playing or storing on the third user's terminal; in connection with sending the requested content item, causing another advertisement to be displayed or played on the third user's terminal; and sharing with the first user another revenue generated from causing the other advertisement to be displayed or played on the third user's terminal in connection with sending the requested content item to the third user's terminal. The said sharing comprises: providing the first user with a first contribution point for causing the advertisement to be displayed or played on the second user's terminal; calculating a portion of the revenue to be shared with the first user using the first contribution point; providing the first user with a second contribution point for causing the advertisement to be displayed or played on the third user's terminal; and calculating a portion of the other revenue to be shared with the first user using the second contribution point.

Still in the foregoing method, the method further comprises: receiving from other users a plurality of requests for the content item for displaying, playing, or downloading on terminals of the other users; in response to each request, sending the requested content item for displaying, playing or storing on each user's terminal; and in connection with each sending of the requested content item, causing an advertisement to be displayed or played on each user's terminal; providing the first user with a contribution point for each causing of the advertisement to be displayed or played of the advertisement; accumulating the contribution points of the first user for causing to display or play the advertisement for a period; and calculating a portion of the revenue for sharing with the first user using the accumulated contribution points. The calculating comprises computing a relative contribution of the first user to all users who have posted one or more content items that caused to display or play said advertisement in connection with playing, displaying or downloading of the one or more content items for the period and computing the portion of the revenue for sharing with the first user using the relative contribution of the first user. In the said calculation, computing the relative contribution comprises providing the total contribution points of said all users and dividing the first user's contribution points by the total contribution points of said all users so as to generate a first user's contribution ratio. And computing the portion comprises multiplying the first user's contribution ratio by a fraction of the revenue from said advertisement of assigned for sharing with users.

The foregoing method may comprise: processing records associated with the content item so as to identify a prior poster who had posted the content item on another webpage, wherein the request from the first user is to scrap the content item from the other webpage to said webpage and sharing with the prior poster the revenue generated from causing the advertisement to be displayed or played on the second user's terminal in connection with sending the requested content item to the second user's terminal. The foregoing method may further comprise: receiving a request from the second user for posting said content item on another webpage of said website; posting said content item on the other webpage; receiving from a fourth user a request for said content item for displaying, playing, or downloading on a terminal of the fourth user; sending said requested content item for displaying, playing or storing on the fourth user's terminal; in connection with sending the requested content item to the fourth user's terminal, causing said or another advertisement to be displayed or played on the fourth user's terminal; and sharing with the first user a revenue generated from causing said advertisement or the other advertisement to be displayed or played on the fourth user's terminal in connection with sending the requested content item to the fourth user's terminal. The sharing comprises sharing with the second user revenue generated from causing said advertisement or the other advertisement to be displayed or played on the fourth user's terminal in connection with sending the requested content item to the fourth user's terminal.

Yet still in another embodiment provides a method of sharing an advertisement revenue of a website operation running advertisements The method comprises posting by a first user a content item on a webpage within a website, wherein upon posting and receiving by the first user a portion of an advertisement revenue of the website when posting of the content item has contributed to generating the advertisement revenue by causing one or more selected advertisements to be displayed or played on terminals of other users of the website in connection with displaying, playing or storing of the content item on local terminals of the other users. The first user's posting comprises scraping the content item posted on another webpage of the website or another website.

One aspect of the present disclosure provides an advertising method using a User Created Contents (UCC)-advertisement script. The method may include: transmitting, to a server that stores a plurality of UCC, a request signal for playing random UCC; determining whether the playing of the requested UCC is terminated; transmitting, to a server that stores a plurality of advertisement contents, a request signal for playing random advertisement content using the UCC-advertisement script included in the random UCC, when the playing of the requested UCC is terminated; and playing the requested advertisement content, wherein the UCC-advertisement script includes a command signal to control the advertisement content to be automatically played after the playing of the UCC is terminated.

In the foregoing method, the method may further include: computing a contribution level for each user, wherein the contribution level is a level of contribution that the requested advertisement content made to an advertisement exposure; and allocating advertisement returns to each user in proportion to the computed contribution level.

Still in the foregoing method, the transmitting of the request signal for playing random advertisement content may include: extracting tag information from the random UCC; retrieving an advertisement content that includes the same keyword as or similar to the extracted tag information; and transmitting a request signal for playing the retrieved advertisement content.

Yet in the foregoing method, the tag information may include at least one of a title, a producer, a performer, and a registered time of the UCC. Still in the foregoing method, the computing may compute the contribution level based on at least one of a number of plays of the advertisement content and a number of clonings of the random advertisement content.

Still in the foregoing method, the computing may compute the contribution level of the user by adding a number of plays of the advertisement content on a particular website and a number of plays of the advertisement content on all subsequent websites where the UCC is cloned from the particular website. In order to achieve the above purposes, the disclosure provides a computer-readable recording medium storing a program for implementing the foregoing method.

Another aspect of the disclosure provides an advertising apparatus using a UCC-advertisement script. The apparatus may include: a first transmitting module configured to transmit, to a server that stores a plurality of UCC, a request signal for playing random UCC; a determining module configured to determine whether the playing of the requested UCC is terminated; a second transmitting module configured to transmit, to a server that stores a plurality of advertisement contents, a request signal for playing random advertisement content using the UCC-advertisement script included in the random UCC, when the playing of the requested UCC is terminated; and a play module configured to play the requested advertisement content, wherein the UCC-advertisement script includes a command signal to control the advertisement content to be automatically played after the playing of the UCC is terminated.

One aspect of the disclosure provides an advertising method and apparatus using a UCC-advertisement script that can use a new type of Internet advertisement to thereby improve the diversity of the Internet advertisement and the advertising effect.

Another aspect of the disclosure also provides an advertising method and apparatus using a UCC-advertisement script that can reasonably distribute advertisement returns to a user making contribution to an advertisement exposure on the Internet and thereby can more quickly distribute the advertisement on the Internet.

As described, according to the disclosure, it is possible to improve the advertising effect and enable more quick UCC distribution. In addition thereto, there is no need for an additional server.

### BRIEF DESCRIPTION OF THE DRAWINGS

The above and/or other aspects and advantages of the present disclosure will become apparent and more readily appreciated from the following detailed description, taken in conjunction with the accompanying drawings of which:

FIG. 1 is a block diagram illustrating a configuration of an advertising system using a User Created Contents (UCC)-advertisement script according to one embodiment of the invention;

FIG. 2 illustrates an example of distributing advertisement returns to users by an advertising method and apparatus using a UCC-advertisement script according to one embodiment of the invention;

FIG. 3 illustrates an example of associating UCC with an advertisement content and displaying the same by an advertising method and apparatus using a UCC-advertisement script according to one embodiment of the invention;

FIG. 4 illustrates an example of distributing advertisement returns to a plurality of users based on a contribution level by an advertising method and apparatus using a UCC-advertisement script according to one embodiment of the invention;

FIG. 5 illustrates another example of sharing advertisement revenue to a plurality of users based on a contribution level by an advertising method and apparatus using a UCC-advertisement script according to one embodiment of the invention;

FIG. 6 illustrates still another example of sharing advertisement revenue to a plurality of users based on a contribution level by an advertising method and apparatus using a UCC-advertisement script according to one embodiment of the invention; and

FIG. 7 is a flowchart illustrating an advertising method using an UCC-advertisement script according to one embodiment of the invention.

### DETAILED DESCRIPTION OF EMBODIMENTS

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

Some embodiments include a method of advertising on the Internet by causing an advertisement to be played in connection with playing a content item. And the revenue generated by the advertisement is shared by the users who post the content item causing the advertisement to be played. In this disclosure the term content item refers to a content item that can be displayed or played on a computer or an electronic device for viewing and/or listening. Content item includes, for example, a still image, a motion image, a sound recording, a computer game, a video clip, a song, and etc. A content item can be posted on a webpage so as to be played or downloaded. The webpage is, for example, a page of an internet portal website, a page of content distribution website, a page of an internet search website, a blog page, a page of a social networking website, and etc.

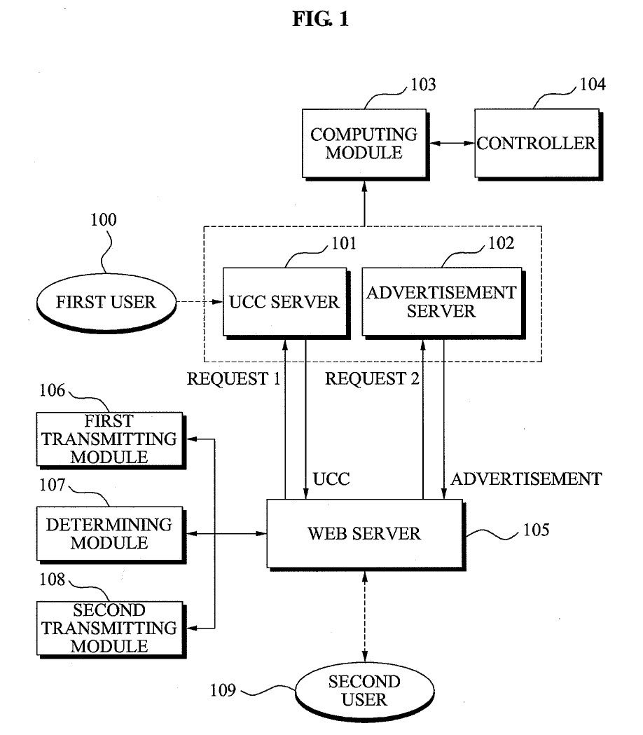

FIG. 1 is a block diagram illustrating a configuration of an advertising system using a User Created Contents (UCC)-advertisement script according to one embodiment of the invention. UCC-advertisement script is configured to cause an advertisement to be displayed or played on a user's computing terminal in connection with sending the user requested UCC for displaying, playing, or storing on the user's terminal. The term “UCC” is an abbreviation of “User Created Contents” and indicates one example of content item that a user of a webpage posts to the webpage. Instead of the term “UCC”, User Generated Contents (UGC) may be used. According to one embodiment of the invention, it is possible to associate an advertisement with the UCC and thereby display both the UCC and the advertisement and enable the quick distribution thereof. Hereinafter, the configuration of the advertising system using the UCC-advertisement script will be described with reference to FIG. 1. However, UCC is one of the examples of a content item and other types of content item may be used in application.

A first user 100 indicates a user that produces UCC and uploads the produced UCC or uploads UCC to a UCC server 101. The UCC server 101 may store the UCC, or may store the UCC with other data.

When a second user 109 desires to play, display, or download random UCC among a plurality of UCC that are stored in the UCC server 101, a first transmitting module 106 may transmit a request signal for playing the random UCC to the UCC server 101. The random UCC may be transmitted from the UCC server 101 and be played, displayed, or downloaded using a web server 105. A determining module 107 may determine whether the playing, displaying, or downloading of the requested UCC is terminated.

When the playing, displaying, or downloading of the UCC is terminated, a second transmitting module 108 may transmit a request signal for playing or displaying random advertisement content to an advertisement server 102 using the UCC-advertisement script included in the random UCC. The advertisement server 102 may store the advertisement content, or may store the advertisement content with other data. The UCC-advertisement script disclosed in the invention comprises a command signal to control the advertisement content to be automatically played or displayed before, after, or while playing, displaying, or downloading the UCC. The names used in this invention are only for convenience of description and thus do not limit the scope of the invention. The UCC-advertisement script may be inserted while the UCC is being initially produced, or may be inserted while the UCC is being played on a particular website.

The first transmitting module 106, the determining module 107, the second transmitting module 108, and the like may be constructed as a program that is installed in a personal computer (PC) of the second user 109, or may be provided in real time via the web server 105.

Accordingly, when the second user 109 accesses the web server 105 using the PC and the like, the second user 109 may automatically view the UCC produced by the first user 100 and may also view the random advertisement content. Accordingly, it is possible to more readily expose the advertisement for a plurality of users, improving the advertising effect. Also, since it is possible to embody the invention using a script without an additional server, efficient use of server resources may be improved.

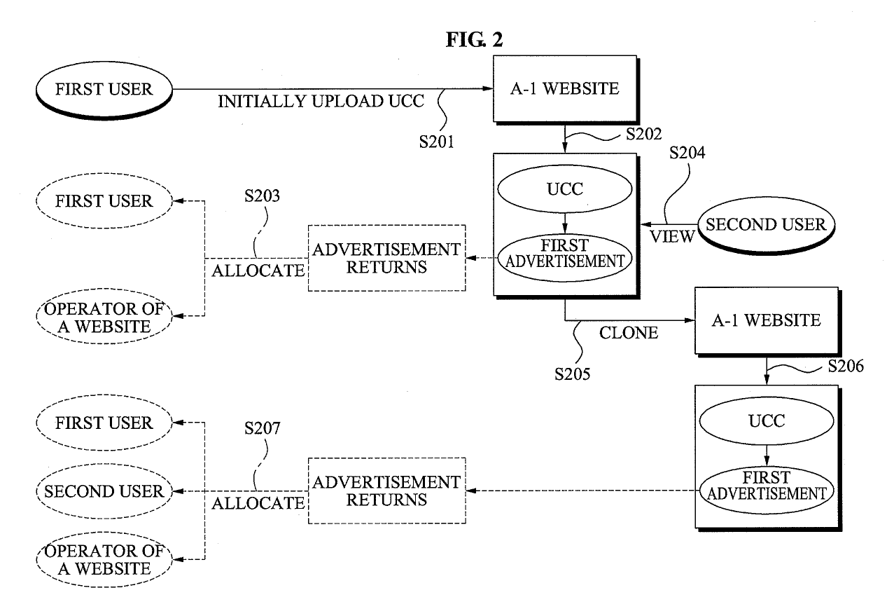

According to one embodiment of the invention, there may be provided a system that can monitor an advertisement content, compute a contribution level or contribution point associated with advertisement exposure for each user, and thereby can reasonably allocate advertisement returns to each user. In FIG. 1, a computing module 103 may compute how frequently the advertisement content is played in the web server 105 and store in a database, a memory, and the like, information about number of plays, play time, number of clonings or scrapings, cloning or scraping path, and the like. A controller 104 may distribute advertisement returns to at least one user in reference to the computed contribution level. A scheme of reasonably distributing advertisement revenue will be described in detail with reference to FIGS. 2, 4, and 5.

According to one embodiment, when the advertisement server 102 transmits an advertisement content to the web server 105, the advertisement server 102 may automatically identify a characteristic of UCC and provide an optimal advertisement content for a user, instead of simply transmitting a random content.

Although not illustrated in FIG. 1, while the UCC is being uploaded, additional information such as a title, a producer, a performer, and a registered time of the UCC may be updated. The additional information may be used as tag information of the UCC. The advertisement server 102 may manage a keyword associated with each advertisement content in the database. Accordingly, the advertisement server 102 may extract the same keyword as or similar to the tag information of the UCC. Specifically, it is possible to combine the extracted particular advertisement content with the UCC, enabling the user to view the UCC and then view the particular advertisement content associated with the UCC. Accordingly, it is possible to significantly increase the user's concentration on the advertisement content.

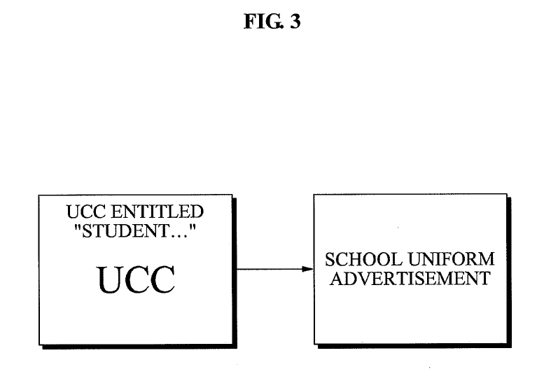

For example, when the first user 100 tags a title that includes the term “student” to UCC and uploads the UCC, the advertisement server 102 may provide an advertisement content associated with the term “student” to the web server 105. Accordingly, the user may view the UCC associated with “student” and then view the associated advertisement content. The advertisement content that includes a keyword associated with “student” may be a school uniform content and the like. Accordingly, as shown in FIG. 3, it is possible to play UCC and an advertisement content associated with the UCC via a particular web server.

FIG. 2 illustrates an example of sharing advertisement revenue to a user by an advertising method and apparatus using a UCC-advertisement script according to one embodiment of the invention. Hereinafter, a basic principle of sharing advertisement returns to a UCC poster, a website operator, and a user that clones or scraps the UCC by the advertising method and apparatus using the UCC-advertisement script will be described with reference to FIG. 2. Again, the description of FIG. 2 is provided with reference to UCC but other content items may be used in place of UCC.

As shown in FIG. 2, in operation S201, a first user may initially upload or post random UCC in an A-1 webpage, wherein the webpage includes a page of an internet portal website, a page of content distribution website, a page of an internet search website, a blog page, or a page of a social networking website. When the user posts a content item (UCC) to these webpages, the user typically identifies the document or file to post and submit to a server computer a request for posting by clicking a link or button for uploading the document or file. The server computer processes the request and posts the document or file so that it is available on the webpage. The first user may be the producer of the UCC as well.

In operation S202, the UCC and a first advertisement may be played on the A-1 webpage. In this case, it can be determined that the first user and an operator of an A website that manages the A-1 webpage make contributions to exposing of the first advertisement. Accordingly, in operation S203, a portion of advertisement revenue may be allocated to the first user and the operator of the A website.

In operation S204, a second user may view the UCC and the first advertisement. Here viewing of the UCC comprises playing, displaying, or downloading of the content item on the user's computing terminal. In operation S205, a second user may scrap the UCC and the first advertisement and then upload the same content to an A-2 webpage. In operation S206, the UCC and a second advertisement may be played on the A-2 webpage. The second advertisement may be the same as the first advertisement and may also be different from the first advertisement. Also, it can be determined that the first user, the operator of the A website that manages the A-2 webpage, and the second user make contributions to exposing of the second advertisement. Accordingly, in operation S207, a portion of remaining advertisement revenue may be allocated to the first user, the A website operator, and the second user.

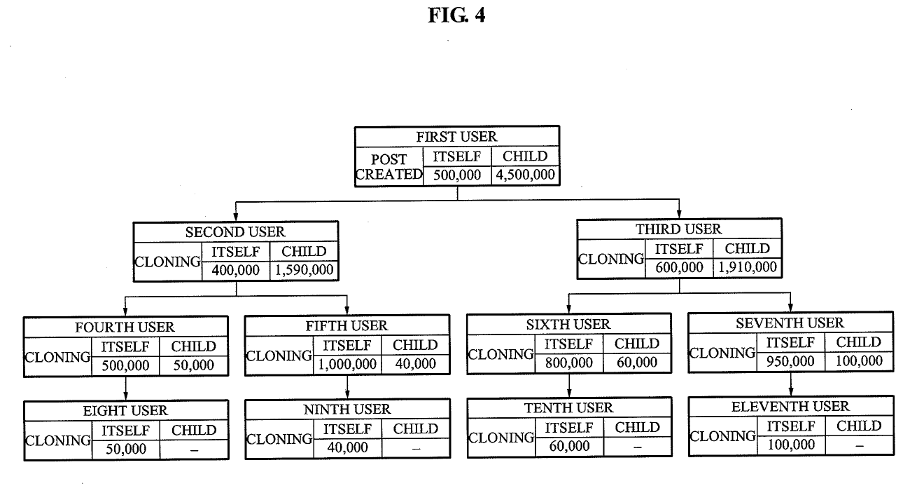

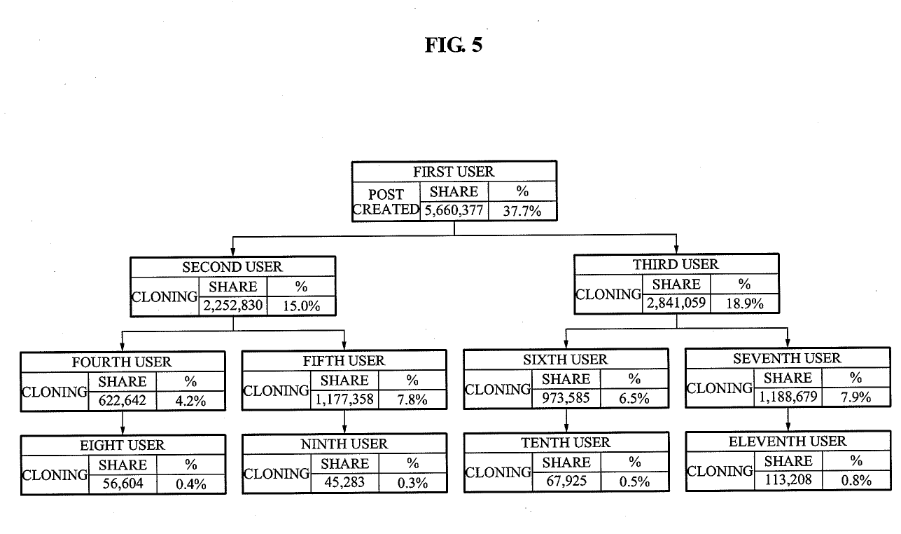

FIG. 4 illustrates an example of sharing advertisement revenues and/or profits with a plurality of users based on a contribution point according to one embodiment of the invention. FIG. 5 illustrates another example of sharing advertisement revenues with a plurality of users based on a contribution point according to one embodiment of the invention. More specifically, FIG. 4 indicates a contribution level or point associated with advertisement exposure of an advertisement content for each user. FIG. 5 indicates an amount of advertisement returns allocated to each user. Hereinafter, an example of sharing advertisement revenue with the plurality of users based on the contribution level will be described with reference to FIGS. 4 and 5.

As shown in FIG. 4, a first user indicates a user that initially uploads a produced UCC to a particular webpage. Second through eleventh users indicate users that clone the uploaded UCC. The cloning indicates an action that scraps the uploaded UCC to another webpage. A numerical value filled in the cell “itself” is a contribution point that indicates how much an advertisement is exposed via a content item. A numerical value filled in the cell “child” is a contribution point that indicates how much the advertisement is exposed via a descendent content item that clones the advertisement from the parent content item. The contribution point of the advertisement exposure may be determined based on the counts of the advertisement sent by the server, counts of the advertisement caused by the content item, or an arbitrary point system. Also, the contribution point of the advertisement exposure may be determined using a different scheme of those skilled in the art.

A contribution point of a user associated with the advertisement exposure may be determined by adding the numerical value of the cell “itself” and the numerical value of cell “child”. For example, referring to FIG. 4, the contribution point of the first user may be computed as “5,000,000” and the contribution point of the second user may be computed as “1,990,000”. As described above, the first user that posts the UCC may be allocated with a predetermined share with respect to a contribution that a subsequent user makes to the advertisement exposure. Accordingly, even when the UCC is played, displayed, or downloaded via the initial uploaded post a relatively less number of times, the user that uploads the UCC may be allocated with the highest share of advertisement revenue.

Advertisement revenues that are allocated to the first through the eleventh users may be determined as shown in FIG. 5. Here, it is assumed that 15,000,000 won is allocated to the first through the eleventh users as advertisement revenue. Advertisement revenue to be allocated to each user may be computed according to {(Contribution points of each user associated with advertisement exposure)/(Contribution points of all the users associated with advertisement exposure)}×(Advertisement revenue allocated to all the users).

For example, advertisement revenue allocated to or shared by the first user may be computed as 5,660,377 won that is obtained from {(5,000,000/13,250,000)×15,000,000 won}. Advertisement revenue allocated to the second user may be computed as 2,252,830 won that is obtained from {(1,990,000/13,250,000)×15,000,000 won}.

Although not illustrated, every time UCC is uploaded, or is scraped and is uploaded, the process is performed via a server of a particular website. Accordingly, it is possible to distribute advertisement returns to an operator of the particular website using the same scheme as the scheme of sharing advertisement revenue with all the users.

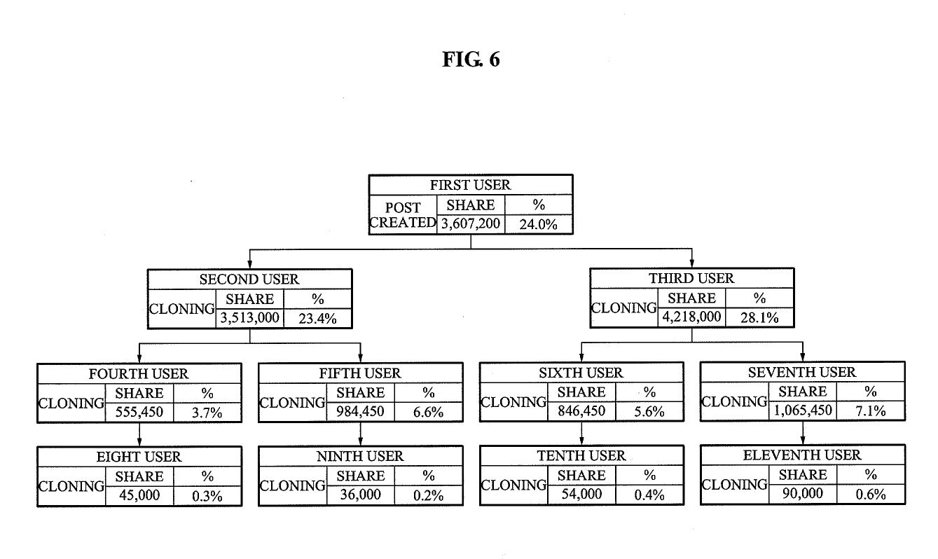

FIG. 4 illustrates an example of sharing advertisement revenue with a plurality of users based on a contribution level or point according to one embodiment of the invention. FIG. 6 illustrates still another example of sharing advertisement revenue with a plurality of users based on a contribution level according to one embodiment of the invention. More specifically, FIG. 4 indicates contribution that each user makes in exposing an advertisement content. FIG. 6 indicates an amount of advertisement revenue that each user shares based on the result of FIG. 4. Hereinafter, a scheme of sharing advertisement revenue to the plurality of users based on the contribution level will be described with reference to FIGS. 4 and 6.

The embodiment of FIG. 6 is different from the above-described embodiment with reference to FIG. 5. In FIG. 6, in addition to the contribution level associated with the advertisement exposure, advertisement revenue may be distributed based on cloning or scraping. In FIG. 5, all the subsequent or descendent webpages where the UCC is cloned from the particular website are considered. However, in FIG. 6, only a subsequent website where the UCC is directly cloned from the particular website is considered.

The advertisement revenue shared with each of the first through the eleventh users shown in FIG. 4 may be determined as shown in FIG. 6. The sharing of advertisement revenue shown in FIG. 6 may be computed by adding sharing of advertisement revenue based on advertisement exposure for each user to sharing of advertisement revenue based on a number of scrapings. Hereinafter, it will be described in detail using an example.

Referring to FIG. 6, a share amount of advertisement revenue based on the advertisement exposure of the first user may be given by,

A reward amount to the first user for posting a content item={(Contribution points of first user generated by the his or her own posting)×(A coefficient)+(Contribution points of second user generated by the his or her own posting)×(The coefficient)×(A share rate allocated for a parent website)+(Contribution points of third user generated by the his or her own posting)×(The coefficient)×(The share rate allocated for a parent website)}. [Equation 1]

When entering specific numerical values in Equation 1, it may be represented as,

7200000={(500000×6)+(400000×6×70%)+(600000×6×70%)}.

According to one embodiment, the computed share amount of advertisement revenue based on the advertisement exposure of the first user may be designed to be shared with the operator of the particular website at the ratio of 1 to 1. Accordingly, 3,600,000 won may be allocated to the first user as the actual share amount.

Referring to FIG. 6, a share amount of advertisement revenue based on a number of clonings of the first user may be given by,

A reward amount to the first user for clonings of his/her content item posted={(The number of clonings of first user)×(Cost per cloning)+(The number of clonings of second user)×(Cost per cloning)×(A share rate allocated for a parent website)+(The number of clonings of third user)×(Cost per cloning)×(The share rate allocated for a upper website)}. [Equation 2]

When entering specific numerical values in Equation 2, it may be represented as,

14400={(2×3000)+(2×3000×70%)+(2×3000×70%)}.

According to one embodiment, the computed distribution amount of advertisement revenue based on the number of clonings of the first user may be designed to be shared with the operator of the particular website at the ratio of 1 to 1. Accordingly, 7,200 won may be allocated to the first user as the actual distribution amount.

Accordingly, a total amount of 3,607,200 won that is an addition of the computed distribution amount, 3,600,000 won, of advertisement revenue based on the advertisement exposure allocated for the first user and the computed distribution amount, 7,200 won, of advertisement revenue based on the number of clonings of the first user may be allocated to the first user.

Referring to FIG. 6, a distribution amount of advertisement revenue based on advertisement exposure of the second user may be given by,

A reward amount to the second user for posting a content item={(Contribution points of second user generated by his or her own posting)×(A coefficient)×(A share rate allocated for a descendent website)+(Contribution points of fourth user)×(The coefficient)×(A share rate allocated for a parent website)+(Contribution points of fifth user)×(The coefficient)×(The share rate allocated for a parent website)}. [Equation 3]

When entering specific numerical values in Equation 3, it may be represented as,

7020000={(400000×6×30%)+(500000×6×70%)+(1000000×6×70%)}.

According to one embodiment, the computed distribution amount of advertisement revenue based on the advertisement exposure of the second user may be designed to be shared with the operator of the particular website at the ratio of 1 to 1. Accordingly, 3,510,000 won may be allocated to the second user as the actual distribution amount.

Referring to FIG. 6, a distribution amount of advertisement revenue based on a number of clonings of the second user may be given by,

A reward amount to the second user for clonings of his/her content item posted={(The number of clonings of second user)×(Cost per cloning)×(A share rate allocated for a descendent website)+(The number of clonings of fourth user)×(Cost per cloning)×(A share rate allocated for a parent website)+(The number of clonings of fifth users)×(Cost per cloning)×(The share rate allocated for a parent website)}. [Equation 4]

When entering specific numerical values in Equation 4, it may be represented as,

6000={(2×3000×30%)+(1×3000×70%)+(1×3000×70%)}.

According to one embodiment, the computed share amount of advertisement revenue based on the number of clonings of the second user may be designed to be shared with the operator of the particular website at the ratio of 1 to 1. Accordingly, 3,000 won may be allocated to the second user as the actual share amount.

Accordingly, a total amount 3,513,000 won that is an addition of the computed share amount of, 3,510,000 won, of advertisement revenue based on the advertisement exposure allocated for the second user and the computed share amount, 3,000 won, of advertisement revenue based on the number of scrapings of the second user may be allocated to the second user.

According to one embodiment shown in FIG. 6, since a contribution level or point of a website where cloning is directly performed is shared with a parent website and a subsequent website at a predetermined ratio, it is possible to reasonably share advertisement revenue. Also, since an additional sharing is performed based on a number of clonings or scraps, a user of a website that is being cloned may be satisfied with the result of the share. Descriptions made with reference to FIG. 6 may be only an example and thus this invention is not limited thereto.

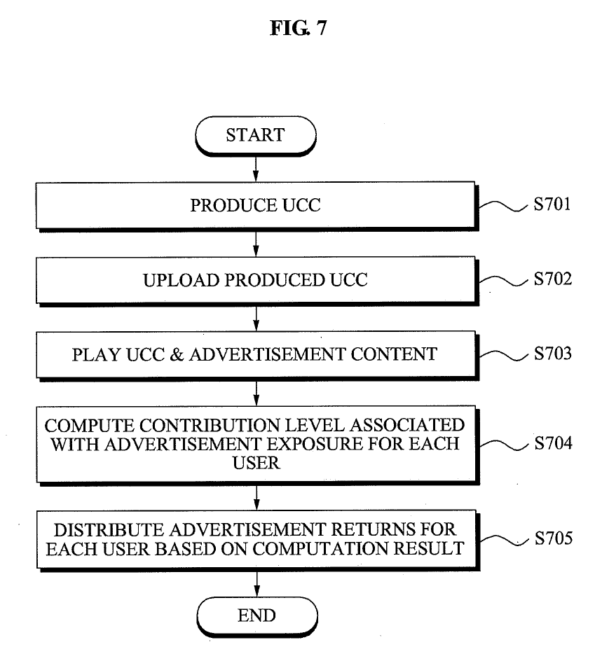

FIG. 7 is a flowchart illustrating an advertising method using an UCC-advertisement script. Hereinafter, the advertising method using the UCC-advertisement script will be described with reference to FIG. 7. And again, UCC is being used in the example of the embodiment but any content item may be used in application.

In operation S701, a user may produce UCC. The UCC may be a still image or a moving picture photographed by a digital camera, a camcorder, a mobile phone, and the like. The UCC may indicate edited data. In operation S7202, the user may upload the produced UCC to a particular webpage, wherein the webpage is selected from the group consisting of a page of an internet portal website, a page of content distribution website, a page of an internet search website, a blog page, and a page of a social networking website. In operation S703, when a command for playing the UCC is received, an advertisement content may be played after playing of the UCC is terminated. Depending on embodiments, the playing order may be reversed.

In operation S704, a contribution level or point associated with advertisement exposure of the advertisement content may be computed for each user. The user may include a UCC producer, a user that clones or scraps the UCC, and the like. In operation S705, advertisement revenue may be distributed for each user based on the computation result.

The advertising method using the UCC-advertisement script or content item causing an advertisement to be played according to the above-described exemplary embodiment of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, and the like, including a carrier wave transmitting signals specifying the program instructions, data structures, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention.

The conventional advertising method and apparatus using the Internet have had problems as follow. According to the conventional art, since an old-styled scheme of the banner advertisement is generally used for the Internet advertisement, the diversity of the Internet advertisement and the advertising effect may be deteriorated. Also, there does not exist a system that can assign a weight to a user making a contribution to an advertisement exposure on the Internet. Therefore, the advertisement distribution may become sluggish on the Internet. And according to the conventional art, there may be no relation between the banner advertisement and a website that the user is currently being viewed or being used. Therefore, it may be difficult to attract the user's concentration into the Internet advertisement.

However, According to embodiments of the invention, it is possible to use a new type of Internet advertisement to thereby improve the diversity of the Internet advertisement and the advertising effect. Therefore, an advertising inventory may be expanded and a new income source may be created.

Also, according to embodiments of the invention, it is possible to reasonably distribute advertisement revenue to a user making contribution to advertisement exposure on the Internet and thereby more quickly distribute the advertisement on the Internet.

Also, according to embodiments of the invention, it is possible to embody the invention by adding a script to UCC, without adding a separate server. Therefore, it is possible to improve the efficiency of resources. Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method of sharing an advertisement revenue, the method comprising:
receiving a request from a first user for posting a content item on a webpage of a website;
posting the content item on the webpage;
receiving from a second user a request for the content item for displaying, playing, or downloading on a terminal of the second user;
sending the requested content item for displaying, playing or storing on the second user's terminal;
in connection with sending the requested content item, causing an advertisement to be displayed or played on the second user's terminal; and
sharing with the first user a revenue generated from causing the advertisement to be displayed or played on the second user's terminal in connection with sending the requested content item to the second user's terminal.

2. The method of claim 1, wherein the request for posting comprises a request for scraping the content item from another webpage that has posted the content item.

3. The method of claim 1, wherein causing comprises sending the advertisement to the second user's terminal or sending a command to the second user's terminal to play or display the advertisement that has been stored in the second user's terminal.

4. The method of claim 1, wherein causing is to make the advertisement displayed or played before or after displaying, playing or storing of the content item on the second user's terminal.

5. The method of claim 1, wherein causing is to make the advertisement displayed or played while displaying, playing or storing of the content item on the second user's terminal.

6. The method of claim 1, wherein the content item comprises data to be displayed or played on a computing terminal and further comprises information identifying the advertisement, wherein the method further comprises selecting the advertisement by referring to the information upon receiving the request for the content item.

7. The method of claim 1, wherein the content item comprises data to be displayed or played on a computing terminal and further comprises information describing the content item, wherein the method further comprises selecting the advertisement by referring to the information and referring to an advertisement database.

8. The method of claim 7, wherein selecting the advertisement comprises:
processing the information so as to extract at least one keyword; and
searching in the advertisement database using the at least one keyword so as to locate said advertisement.

9. The method of claim 7, wherein the information describing the content item is incorporated in the content item while creating the content item or when the content item is uploaded.

10. The method of claim 7, wherein the information is selected from the group consisting of a title of the content item, one or more descriptive keywords for the content item, one or more names of creator(s) of the content item, one or more names of contributor(s) of the content item, date or time of creating of the content item, and date or time of posting of the content item.

11. The method of claim 1, wherein posting comprises providing an anchor tag on the webpage for initiating to play or display the content item on a computing device connected to the webpage.

12. The method of claim 1, wherein sharing comprises:
providing the first user with a contribution point for causing the advertisement to be displayed or played on the second user's terminal; and
calculating a portion of the revenue to be shared with the first user using the contribution point.

13. The method of claim 1, further comprising:
receiving from a third user a request for the content item for displaying, playing, or downloading on a terminal of the third user;
sending the requested content item for displaying, playing or storing on the third user's terminal;
in connection with sending the requested content item, causing another advertisement to be displayed or played on the third user's terminal; and
sharing with the first user another revenue generated from causing the other advertisement to be displayed or played on the third user's terminal in connection with sending the requested content item to the third user's terminal.

14. The method of claim 13, wherein sharing comprises:
providing the first user with a first contribution point for causing the advertisement to be displayed or played on the second user's terminal;
calculating a portion of the revenue to be shared with the first user using the first contribution point;
providing the first user with a second contribution point for causing the advertisement to be displayed or played on the third user's terminal; and
calculating a portion of the other revenue to be shared with the first user using the second contribution point.

15. The method of claim 1, further comprising
receiving from other users a plurality of requests for the content item for displaying, playing, or downloading on terminals of the other users;
in response to each request, sending the requested content item for displaying, playing or storing on each user's terminal;
in connection with each sending of the requested content item, causing an advertisement to be displayed or played on each user's terminal;
providing the first user with a contribution point for each causing of the advertisement to be displayed or played of the advertisement;
accumulating the contribution points of the first user for causing to display or play the advertisement for a period; and
calculating a portion of the revenue for sharing with the first user using the accumulated contribution points.

16. The method of claim 15, wherein calculating comprises:
computing a relative contribution of the first user to all users who have posted one or more content items that caused to display or play said advertisement in connection with playing, displaying or downloading of the one or more content items for the period; and
computing the portion of the revenue for sharing with the first user using the relative contribution of the first user.

17. The method of claim 16, wherein computing the relative contribution comprises:
providing the total contribution points of said all users; and
dividing the first user's contribution points by the total contribution points of said all users so as to generate a first user's contribution ratio.

18. The method of claim 17, wherein computing the portion comprises multiplying the first user's contribution ratio by a fraction of the revenue from said advertisement of assigned for sharing with users.

19. The method of claim 1, further comprising:
processing records associated with the content item so as to identify a prior poster who had posted the content item on another webpage, wherein the request from the first user is to scrap the content item from the other webpage to said webpage; and
sharing with the prior poster the revenue generated from causing the advertisement to be displayed or played on the second user's terminal in connection with sending the requested content item to the second user's terminal

20. The method of claim 1, further comprising:
receiving a request from the second user for posting said content item on another webpage of said website;
posting said content item on the other webpage;
receiving from a fourth user a request for said content item for displaying, playing, or downloading on a terminal of the fourth user;
sending said requested content item for displaying, playing or storing on the fourth user's terminal;
in connection with sending the requested content item to the fourth user's terminal, causing said or another advertisement to be displayed or played on the fourth user's terminal; and
sharing with the first user a revenue generated from causing said advertisement or the other advertisement to be displayed or played on the fourth user's terminal in connection with sending the requested content item to the fourth user's terminal.

21. The method of claim 1, further comprising:
sharing with the second user a revenue generated from causing said advertisement or the other advertisement to be displayed or played on the fourth user's terminal in connection with sending the requested content item to the fourth user's terminal.

22. A method of sharing an advertisement revenue of a website operation running advertisements, the method comprising:
posting by a first user a content item on a webpage within a website, wherein upon posting; and
receiving by the first user a portion of an advertisement revenue of the website when posting of the content item has contributed to generating the advertisement revenue by causing one or more selected advertisements to be displayed or played on terminals of other users of the website in connection with displaying, playing or storing of the content item on local terminals of the other users.

23. The method of claim 22, wherein the first user's posting comprises scraping the content item posted on another webpage of the website or another website.
